(19) United States
(12) Patent Application Publication
(10) Pub. No.: US 2011/0090454 A1
(43) Pub. Date: Apr. 21, 2011

(54) CURVED CORRECTIVE LENSES CONFIGURED TO DECODE THREE-DIMENSIONAL CONTENT

(76) Inventors: David A. Johnson, Del Mar, CA (US); James Pritts, Emerald Hills, CA (US)

(21) Appl. No.: 12/781,590

(22) Filed: May 17, 2010

Related U.S. Application Data
(60) Provisional application No. 61/178,609, filed on May 15, 2009.

(51) Int. Cl. G02C 7/12; G02C 7/10

(52) U.S. Cl. 351/163; 351/159; 351/177

(57) ABSTRACT

Curved corrective lens configured to decode three dimensional content. The corrective lens may include a wafer formed of a high efficiency polarizer material layer over a lamination layer over an adhesion layer over a retardation layer, and a lens material to which the wafer is integrated and into which a prescription is ground. Photochromic materials may also be used to provide a self-darkening feature.

### CROSS-REFERENCE

This application claims the benefit of Provisional Application No. 61/178,609 filed on May 15, 2009, which is incorporated herein by reference in its entirety for all purposes.

### FIELD OF THE INVENTION

The embodiments of the present invention relate to prescription lenses designed to decode three dimensional content displayed on television, movie, computer or similar screens or monitors.

### BACKGROUND

Three dimensional movies for theatres have been around for decades. With technological advances, three dimensional content is being developed for television, computer monitors and home projectors. In the past, and even today, special glasses allow users to view three dimensional content. Flat paper eyeglasses using red and green film for lenses are the primary glasses being used today. However, flat paper eyeglasses are not very effective for facilitating the desired three dimension effect. In addition, the flat paper eyeglasses are not comfortable and are generally viewed as a novelty. Other flat lenses suffer from the same drawbacks.

One advancement has been the development of linear and circular polarization for decoding three dimensional content. Despite the advancement, the lens and eyeglass technology has not advanced significantly.

Thus, there is a need for lenses that take advantage of the linear and circular polarization technologies while more effectively creating the desired three dimensional effect. Advantageously, the lenses and eyeglasses should provide improved optics and contrast while providing user comfort and versatility. It is also beneficial if the lenses support a prescription that may be mounted into stylish and comfortable frames fitted to the face of the wearer.

### SUMMARY

Accordingly, one embodiment of the present invention is a curved corrective lens configured to decode three dimensional content comprising: a wafer formed of a high efficiency polarizer material layer over a lamination layer over an adhesion layer over a retardation layer; and a lens material to which said wafer is integrated and into which a prescription is ground.

Another embodiment of the present invention is a method of fabricating a curved corrective lens configured to decode three dimensional content comprising: forming a wafer having a high efficiency polarizer material layer over a lamination layer over an adhesion layer over a retardation layer; integrating said wafer with a lens material; and grinding a prescription into said lens material.

In one embodiment, the retardation film is a norbornene copolymer resin such as an Arton film (manufactured by JSR Corp.) or Zenor film (manufactured by Zeon corp.). Other materials, such as polyurethanes, polycarbonates and polyvinylalcohol (PVA) may also be used as the retardation film. In one embodiment, the retardation layer has a retardation between 110 nm and 150 nm. In another embodiment, the retardation layer has a retardation between 120 nm and 140 nm. The lens materials may be polycarbonate, CR-39, polyurethane, such as Trivex, a PPG material, or MR resins made by Mitsubishi Chemical, polyamide, or other suitable lens materials. The wafers described herein are fabricated using lamination techniques. Photochromic material may also be used to provide a self-darkening feature.

Other variations, embodiments and features of the present invention will become evident from the following detailed description, drawings and claims.

### BRIEF DESCRIPTION OF THE DRAWINGS

FIGS. 1 and 2 illustrate exemplary wafer cross-sections according to the embodiments of the present invention;

FIG. 3 illustrates a flow chart detailing an exemplary method according to the embodiments of the present invention; and

FIG. 4 shows a table listing specifications and performance measurements associated with photochromic sheets.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Traditionally flat lenses and frames have been used in 3D glasses. One problem with the flat 3D glasses is that the lenses are distanced from the user's face and more particularly the user's eyes. Thus, light is able to enter the user's eyes from the top, bottom and side of the lenses reducing the visual acuity and contrast thereby reducing the effectiveness of the 3D experience. This is especially true at home or other locations outside of dark movie theatres. Moreover, the current one-size-fits-all approach to flat 3D eyeglasses reduces the quality of the 3D experience and results in an uncomfortable fit for many users. Accordingly, the embodiments of the present invention overcome the disadvantages of the prior art flat 3D eyeglasses by creating 3D lenses and eyeglasses which are more akin to normal curved lenses and eyeglasses. Consequently, the lenses described herein are generally thicker than traditional flat 3D lenses and curved to prevent ambient light from interfering with the 3D experience. Conventional flat 3D paper lenses are around 0.3 to 0.4 mm thick or less. The curvature further enables a better fit on the user's head. In addition, the thicker lenses enable them to be reliably mounted into stylish frames to which people are more accustomed. Moreover, the lenses described herein are corrective thus allowing a user to view 3D content with clarity. The prior art systems rely on separate, flat 3D glasses or lenses which are positioned over a pair a corrective eyeglasses. Users who need eyeglasses thus have had to wear the uncomfortable flat 3D glasses over (on top of) their corrective eyeglasses, requiring them to look through 2 pairs of lenses, with contrast and acuity compromised by reflections from four lens surfaces.

Prescription or corrective lenses are made of plastic or glass and most are made in a generally conventional fashion. The method comprises: selecting a lens blank with the proper base curve; if required, the lens blank is marked to identify the location of a cylinder axis; front of the blank is covered with tape or other protective covering; a compound grinder is then used to grind the curves in the back of the lens blank; a cylinder machine in then used to sand the lens; the lens is then polished; an edger is then used to cut the lens into the shape of a frame; and the lens may be inserted into the frame. In recent years the introduction of automated digital and free-form technology has enabled labs to produce highly customized lens designs, including progressive multi-focal lenses, which can provide both improved efficiencies and superior optics.

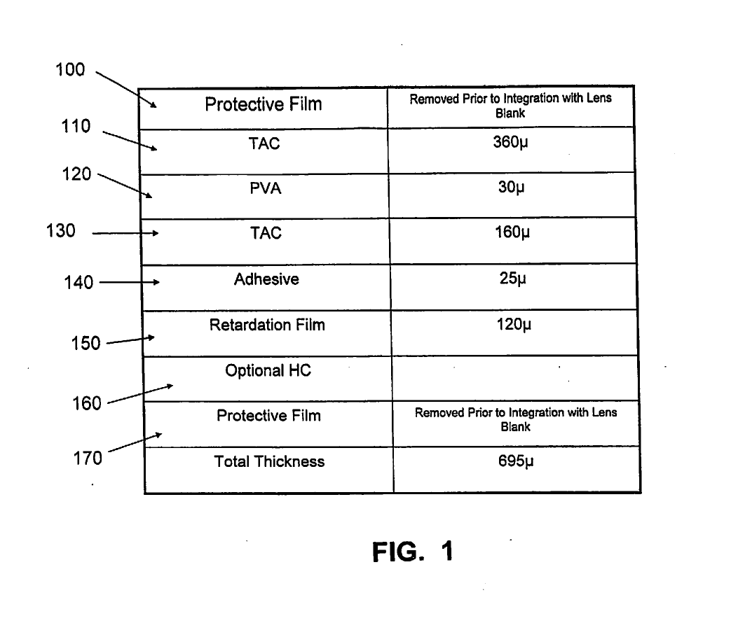

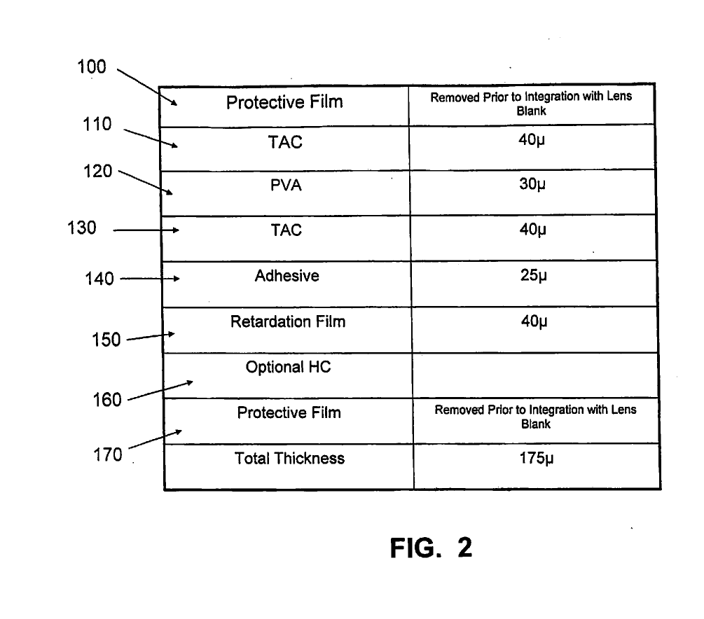

FIGS. 1 and 2 show exemplary wafer cross-sections according to the embodiments of the present invention. FIG. 1 shows a cross-section corresponding to a thick wafer while FIG. 2 shows a cross-section corresponding to a thin wafer for use with prescription lens blanks. The terms thick and thin as used herein are relative to one another. In other words, the use of the terms thick wafers and thin wafers is not intended to limit the possible range of thicknesses of the wafers according to the embodiments of the present invention. Thus, the wafers according to the embodiments of the present invention may be thicker or thinner than the exemplary wafers shown in FIGS. 1 and 2, respectively.

In each instance shown in FIGS. 1 and 2, the wafer for use with prescription lens blanks comprises the same components and number of layers but with different thicknesses. The wafers include a first protective film layer 100, first triacetate layer 110, polyvinylalcohol polarizer film layer 120, second triacetate layer 130, adhesive layer 140, retardation film layer 150, an optional hard coat layer 160 and second protective film layer 170. Without the hard coat layer 160 applied to the sheets, a lab may apply a hard coat layer on both sides (e.g., by dipping) which may have increase scratch resistance over a thermoformable hard coat layer applied to the sheets. As shown in FIG. 1, the thick wafer is 595 microns thick while the thin prescription wafer shown in FIG. 2 is 175 microns thick. In one embodiments of the present invention, the reduction in thickness of the wafers is primarily a function of reducing the thickness of the first triacetate layer 110, second triacetate layer 130 and retardation film layer 150. Those skilled in the art will recognize that the thicknesses of the wafers may be greater than or less than shown in FIGS. 1 and 2. Moreover, it will be recognized that the thicknesses may be altered by manipulating the thicknesses of the layers in any number of conceivable manners.

The exemplary wafers shown in FIGS. 1 and 2 are fabricated using lamination techniques involving one or more layers of suitable adhesives.

Integrating the wafer and prescription lens blank is accomplished using injection molding, casting and/or lamination techniques. With injection molding, the wafer is introduced into the mold after which a lens material (e.g., polycarbonate, polyurethane, polysulfone, cellulose ester resin, homopolymer or copolymer of (meth)acrylates, polyamide, copolymer of olefin, or copoloymer of cycloolefin.) may be injected into the mold to form a clear layer on the back of the wafer. A prescription may then be ground into a back of the clear layer and a hard coat applied in a manner as described above. The polarizing film should be heat resistant to withstand the heat associated with the injection molding or curing process associated with casting. With casting wherein lens materials like Trivex, CR-39, high index or polyurethane are used, the wafer is suspended in a mold and the lens material is cast on back and/or front of the wafer. A prescription may then be ground into back layer of the lens material and a hard coat applied in a manner as described above. With lamination, the wafer is laminated to a pre-fabricated semi-finished clear lens blank. The lamination is accomplished using a suitable adhesive or autoclave under heat and pressure. A prescription may then be ground into back layer of the clear lens blank and a hard coat applied in a manner as described above. The injection molding, casting and lamination methods are well-documented in U.S. Pat. No. 7,036,932 which is incorporated herein by reference.

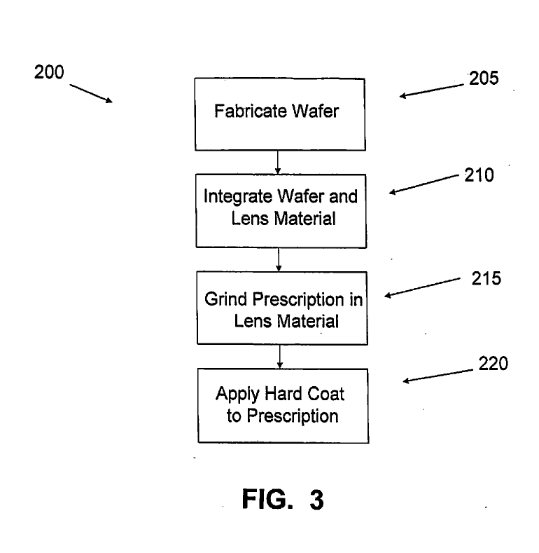

FIG. 3 shows a flow chart 200 detailing one exemplary method of fabricating 3D corrective lenses according to the embodiments of the present invention. At 205, a wafer having a first protective film layer 100, first triacetate layer 110, polyvinylalcohol polarizer film layer 120, second triacetate layer 130, adhesive layer 140, retardation film layer 150, hard coat layer 160 and second protective film layer 170 is formed using lamination techniques. At 210, after the protective film layers 100, 170 are removed, the wafer in integrated with lens material using injection molding, casting and/or lamination techniques. At 215, a prescription is ground into a back of the formed lens opposite the wafer. At 220, a hard coat is applied to the ground prescription side of the lens.

In one embodiment, Trivex is used as the lens material. In such an embodiment, it may be necessary to fix the retarder layer with a chemical barrier to prevent the Trivex from interacting with the retarder layer. Alternatively or additionally, a secondary layer of polyvinylalcohol may be applied to the retarder layer to prevent unwanted interaction between the Trivex and retarder layer.

For the circular polarized lenses utilized in the embodiments of the present invention the polyvinylalcohol polarizer film is tinted and stretched in a linear direction to orient the polymer molecules. Polyiodine molecules are commonly used to allow polarizing efficiency and transmission to reach acceptable levels (e.g., >99% and >35%, respectively). Alternatively, dichroic dyes can be used to provide improved resistance to heat and humidity, but may have slightly lower polarizing efficiency and transmission. Both embodiments can produce the desired 3D decoding effect.

In another embodiment, the corrective 3D lenses are fabricated with a photochromic material which causes the corrective 3D lenses to darken responsive to sunlight (e.g., UV rays from the sun). In one embodiment, using casting techniques, the corrective 3D photochromic lenses include a photochromic triacetate layer sandwiched between the retarder layer and polarizer layer. The lens material (e.g., Trivex) in front of the wafer is non-UV based so that the photochromic fully activates while the lens material in back of the wafer is UV absorbing. While triacetate is one material that can be used with the photochromic materials, others include polycarbonate, poly(methyl methacrylate), polystyrene, polyamide, cellulose acetate butyrate (CAB), cellulose acetate, cellulose diacetate (DAC) or cellulose triacetate (TAC), diacetate and similar stress-free (no birefringence) materials.

Alternative approaches to fabricating corrective 3D photochromic lenses using casting techniques include coating a non-photochromic 3D wafer with a photochromic coating, and mixing or blending photochromic dyes with a non-UV lens material in front of the retarder layer.

Corrective 3D photochromic lenses may also be fabricated using injected molded techniques. In one embodiment, the wafer is constructed as a triacetate (TAC) layer/polyvinylalcohol (PVA) retarder layer/triacetate (TAC) layer/polyvinylalcohol (PVA) polarizer layer/triacetate (TAC) layer/polycarbonate (PC) layer). The inside PC layer is needed for good adhesion to the PC injected lens material. In this type of configuration the photochromic layer is integrated into one or more triacetate (TAC) layers on the front, or via coating as described above relative to casting corrective 3D photochromic lenses.

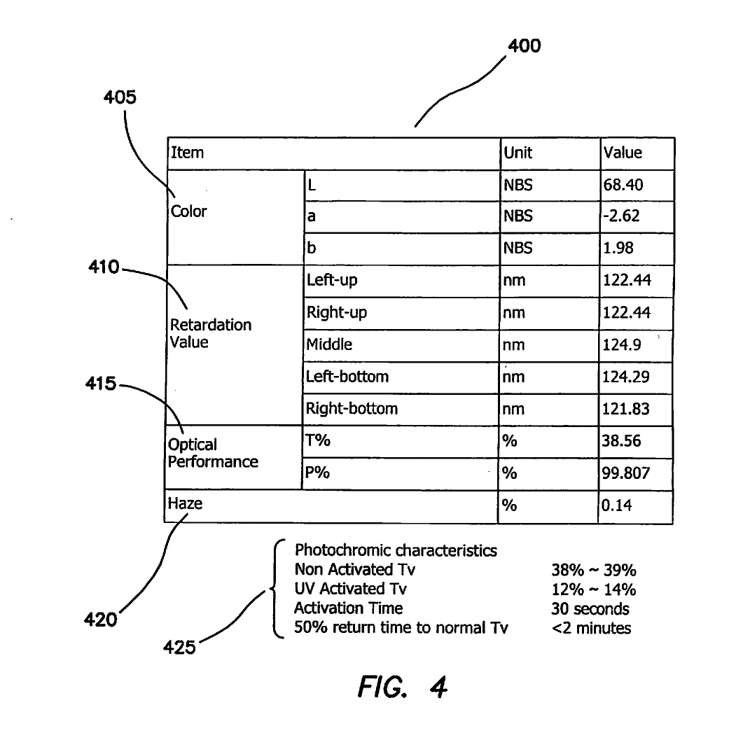

FIG. 4 shows a table 400 listing specifications and performance measurements associated with photochromic sheets from which lens blanks are cut. Color values 405 comprise L, a and b which are color coordinates indicating a lens color. The given color values 405 are indicative of a neutral color which is advantageous with circular polarized 3D eyewear to preserve the color of the content. Units are determined by National Bureau of Standards (NBS) which maintain such units. Retardation values 410, refers to measurement values taken at different location on the photochromic sheet evidencing that the consistency of retardation can be maintained after lamination of the photochromic TAC layer. Optical performance characteristics 415 comprise T % which is visible light transmission of the photochromic sheet in an unactivated state and P % (also referenced as to as PE) which is polarization efficiency of the linear polarizer component. Haze 420 is the % of light which is scattered within the photochromic sheet and measures clarity. Characteristics 425 associated with the photochromic sheet are listed in FIG. 4 as well. Those skilled in the art will recognize that the specifications listed in table 400 and associated characteristics 425 are exemplary and may be modified while continuing to perform as described herein.

The curved corrective lenses disclosed herein have numerous advantages over the flat 3D glasses of the prior art. The curved lenses provide a clear and natural vision of 3D images with greater acuity and contrast. More particularly, the curved lenses reduce light entering the user's eyes from the side, top or bottom of the eyeglass frames thereby increasing the comfort and contrast associated with the viewed 3D images. The curved lenses can be fitted into any commercial eyeglass frame to create as stylish pair of eyeglasses. The curved lenses also allow a user to view 3D content clearly utilizing the user's normal prescription.

Although the invention has been described in detail with reference to several embodiments, additional variations and modifications exist within the scope and spirit of the invention as described and defined in the following claims.

I claim:

1. A curved corrective lens configured to decode three dimensional content comprising:
a wafer formed of a high efficiency polarizer material layer over a lamination layer over an adhesion layer over a retarder layer; and
a lens material to which said wafer is integrated and into which a prescription is ground.

2. The lens of claim 1 wherein said polarizer material layer is tinted with iodine crystals or dichroic dyes.

3. The lens of claim 1 wherein said wafer further comprises a second lamination layer on an opposite side of said polarizer material layer.

4. The lens of claim 1 wherein said wafer further comprises a second adhesion layer for facilitating bonding between said wafer and said lens material.

5. The lens of claim 1 wherein said wafer and lens material are integrated using injection molding, casting and/or lamination techniques.

6. The lens of claim 1 wherein said polarizer material layer comprises one or more of the following: polyvinylalcohol or polyethylene terephthalate.

7. The lens of claim 1 wherein said lamination layer comprises one or more of the following: polycarbonate, poly(methyl methacrylate), polystyrene, polyamide, cellulose acetate butyrate (CAB), cellulose acetate, cellulose diacetate (DAC) or cellulose triacetate (TAC).

8. The lens of claim 1 wherein said lens material comprises one or more of the following: polycarbonate, polyurethane, polysulfone, cellulose ester resin, homopolymer, copolymer of (meth)acrylates, polyamide, copolymer of olefin, or copoloymer of cycloolefin.

9. The lens of claim 1 wherein said retarder layer comprises one or more of the following: copolymer resin, film, polyurethane, polycarbonate or polyvinylalcohol (PVA).

10. The lens of claim 1 further comprising a photochromic triactetate layer between said retarder layer and polarizer layer.

11. The lens of claim 1 further comprising a photochromic coating over said lens material.

12. A method of fabricating a curved corrective lens configured to decode three dimensional content comprising:
forming a wafer having a high efficiency polarizer material layer over a lamination layer over an adhesion layer over a retardation layer;
integrating said wafer with a lens material; and
grinding a prescription into said lens material.

13. The method of claim 12 further comprising tinting said polarizer material layer with iodine crystals or dichroic dyes.

14. The method of claim 12 further comprising forming said wafer having a second lamination layer on an opposite side of said polarizer material layer.

15. The method of claim 12 further comprising forming said wafer having a second adhesion layer for facilitating bonding between said wafer and said lens material.

16. The method of claim 12 further comprising integrating said wafer and lens material using injection molding, casting and/or lamination techniques.

17. The method of claim 12 further comprising forming said wafer utilizing a polarizer material layer having one or more of the following: polyvinylalcohol or polyethylene terephthalate.

18. The method of claim 12 further comprising forming said wafer utilizing said lamination layer having one or more of the following: polycarbonate, poly(methyl methacrylate), polystyrene, polyamide, cellulose acetate butyrate (CAB), cellulose acetate, cellulose diacetate (DAC) or cellulose triacetate (TAC).

19. The method of claim 12 further comprising integrating said wafer with a lens material comprising one or more of the following: polycarbonate, polypolyurethane, polysulfone, cellulose ester resin, homopolymer, copolymer of (meth)acrylates, polyamide, copolymer of olefin, or copoloymer of cycloolefin.

20. The lens of claim 12 wherein said retarder layer comprises one or more of the following: copolymer resin, film, polyurethane, polycarbonate or polyvinylalcohol (PVA).

21. The lens of claim 12 further comprising a photochromic triactetate layer between said retarder layer and polarizer layer.

22. The lens of claim 12 further comprising a photochromic coating over said lens material.

23. A curved corrective lens configured to decode three dimensional content comprising:
a wafer formed of a high efficiency polarizer material layer over a lamination layer over an adhesion layer over a retarder layer;
a photochromic material layer between said high efficiency material layer and said retarder layer;
a non-UV lens material on a front of said wafer and a UV-absorbing material on a back of said wafer; and
a prescription ground into said lens material.

24. A curved corrective lens configured to decode three dimensional content comprising:
a wafer formed of a high efficiency polarizer material layer over a lamination layer over an adhesion layer over a retarder layer, said retarder layer having a surface treated with a chemical barrier to prevent unwanted interaction between said retarder layer and lens material; and
said lens material integrated with said wafer, said lens material having a prescription ground therein.
